(19) United States
(12) Patent Application Publication
(10) Pub. No.: US 2022/0261628 A1
(43) Pub. Date: Aug. 18, 2022

(54) Apparatus for Data Coverage Analysis in AI systems

(71) Applicants: Nagarjun Pogakula Surya, Bangalore (IN); Gomathi Sankar, Kalyannagar (IN); Fuk Ho Pius Ng, Sunnyvale, CA (US); Satish Padmanabhan, Sunnyvale, CA (US); Manikandan Manikam, Bangalore (IN)

(72) Inventors: Nagarjun Pogakula Surya, Bangalore (IN); Gomathi Sankar, Kalyannagar (IN); Fuk Ho Pius Ng, Sunnyvale, CA (US); Satish Padmanabhan, Sunnyvale, CA (US); Manikandan Manikam, Bangalore (IN)

(21) Appl. No.: 17/175,921

(22) Filed: Feb. 15, 2021

(51) Int. Cl. G06N 3/08

(52) U.S. Cl. CPC G06N 3/08

(57) ABSTRACT

A method of processing data for an artificial intelligence (AI) system includes extracting features of the data to produce a lower dimensional representation of the data points; grouping the lower dimensional representation into clusters using a clustering algorithm; comparing the classes of data points within the clusters; and identifying unrepresented, under-represented, or misrepresented data.

### BACKGROUND

Artificial Intelligent (AI) systems are often used to classify data into specific classes of interest. Such AI systems include, but not limited to, neural networks, convolutional neural networks, and deep learning systems. The system takes a training data set. The data points in such dataset are classified into one of a defined set of classes. The system is trained to learn the relationship between the given training dataset and the corresponding classification into the classes. The objective is to use the trained system to classify a new datapoint into one of the classes without the need of an expert.

In a typical application, the initial set of dataset, which was used to train the AI system, is not complete of unknown quality. This dataset is referred to as old-data. Additional data points are collected, and the AI system is trained with the additional data points. This additional data set is referred to as new-data. It is with respect to these considerations and others that the invention has been made to provide a systematic approach to enhancement of data quality

### SUMMARY

In a first aspect, systems and methods are disclosed. The method includes:

Processing old-data to extract features and derive a lower dimensional representation of the data points

Processing new-data to extract features and derive a lower dimensional representation of the data points

Applying clustering on the lower-dimensional representation of the old-data and new-data, to create clusters of the data

Comparing the clusters for data points of old-data and classifying the clusters as unrepresented, underrepresented, and well represented.

In the second aspect, systems and methods are disclosed. The method includes:

Processing old-data to extract features and derive a lower dimensional representation of the data points

Applying clustering on the lower-dimensional representation of the old-data to create clusters of the data

Comparing the clusters for data points and classifying the datapoints in them as misrepresented, and correctly-represented.

In a third aspect, a method for implementing the embodiments using a computer that includes one or more hardware processors with processing memory and storage memory. The system may be implemented in a network environment. The system implements clustering and cluster analysis methods to identify unrepresented data points, misrepresented data points and under-represented data points.

The above aspects advantageously improves AI training convergence, resulting in improved computer speed and improved classification accuracy.

### BRIEF DESCRIPTION OF THE DRAWINGS

Non-limiting and non-exhaustive embodiments of the present innovations are described with reference to the following drawings. In the drawings, like reference numerals refer to the like parts throughout the various figures unless otherwise specified. For a better understanding of the described innovations, reference will be made to the following descriptions of various embodiments, which is to be read in association with the accompanying drawings, wherein:

FIG. 1 illustrates a flow chart of a process for Identifying Under-represented and unrepresented clusters.

FIG. 2 illustrates a flow chart of a process for Identifying Misrepresented Data.

FIG. 3 illustrates a system environment of a computer system.

FIG. 4 illustrates a schematic embodiment of a computer system.

FIG. 5 describes one embodiment of training a neural network for feature extraction.

FIG. 6 describes one embodiment of clustering using CF tree.

### DETAILED DESCRIPTION OF THE EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term “neural network” refers to classification models that take an input and provide an output as classification of the input into one of the several classes. This may require training with the input and the desired class of each input. The term “neural network” includes, but not limited to, deep neural networks, recurrent neural networks, convolutional neural networks, region convolutional neural networks, fast region convolutional neural networks, faster region convolutional neural networks.

As used herein the term “training dataset” refers to the data input to the neural network during its training. The training dataset includes, but not limited to, numbers, vectors, sensor data, raw images, pictures, and videos.

As used herein the term “old dataset” refers to the data set that is used to train the AI system. This data set is referred to as old-data. Old-data includes, but not limited to, the training data, the test data, combined data of train and test, and production data used in subsequent training. Such dataset includes, but not limited to, numbers, vectors, sensor data, raw images, pictures, and videos.

As used herein the term “clusters” refers to the grouping of the input points to two or more subsets. Each of the subset is referred to as a cluster.

As used herein the term “new dataset” refers to the data set that is created after the training of the AI system with said old dataset. This newly created dataset is referred to as new-data. New-data includes, but not limited to, the training data, the test data, combined data of train and test, and production data used in subsequent training. Such dataset includes, but not limited to, numbers, vectors, sensor data, raw images, pictures, and videos.

As used herein the term “feature extraction” refers to the processing of the input points to derive a representation of one or more feature of the input data point. The derived representation is referred as the feature of the input datapoint.

As used herein the term “lower dimensional representation” refers to the feature extracted by processing of the input points in the step “feature extraction”. The derived feature is referred as the “lower dimensional representation” of the input datapoint.

Training and Retraining an AI System

The old-data has a number of variations and the AI system is trained to classify each of all such variations into the specific classes.

For example.
The old-data may be of images and the images may have variations such as
   variant 1 in which images are with near-vertical lines (close to 90-degree angle)
   variant 2 in which images are with near-horizontal lines (close to 0-degree angle)
   variant 3 in which images are with elliptical lines
Such images are mapped into two classes
   class A in which no two lines cross
   class B in which at least two lines cross
A variant 1 set of images with vertical lines can contain both class A and class B classes of images.

To train an AI system, old-data is used. The old-data has many variants and each of the data point in the old-data is mapped into a member of a set of classes. An AI system is trained to learn the mapping of a data point to its corresponding class. Once the AI system is sufficiently trained, the AI system is employed to classify a new set of data. This data is named as new-data.

Such new-data includes, but not limited to, a set of test data, and data from a production environment.

The AI system maps the data points in new-data into one of the specified classes. The purpose of training the AI system with old-data is to use the trained AI system to automatically classify the new-data.

In such a system, the old-data is a small sample or subset of the possible variations in the data set.
Such subset may not have sufficient number of data points for some of the possible variants. The variant for which fewer than required data points is included in the old-data is called under-represented variant.
In some cases, the subset may have no data points for some of the possible variants. The variant for which no data point is included in the old-data is called unrepresented variant.

When, the AI system is used to classify a new-data, the AI system will fail for any data point of types under-represented variants and unrepresented variants. The objective is to identify the variants that are under-represented and unrepresented in the old-data using the new-data.

In such a system, the old-data has been manually mapped into the specific classes. This may cause errors which end up mapping one class of data point into some other class. Such data points that are wrongly classified are called misrepresented data. When training an AI system, such misrepresented data cause the system to lose classification accuracy.

When the AI system is used to classify a new-data, the AI system will fail for any data that was similar to the misrepresented data. The objective is to identify the misrepresented data in the old-data.

Illustrative Operating Environment

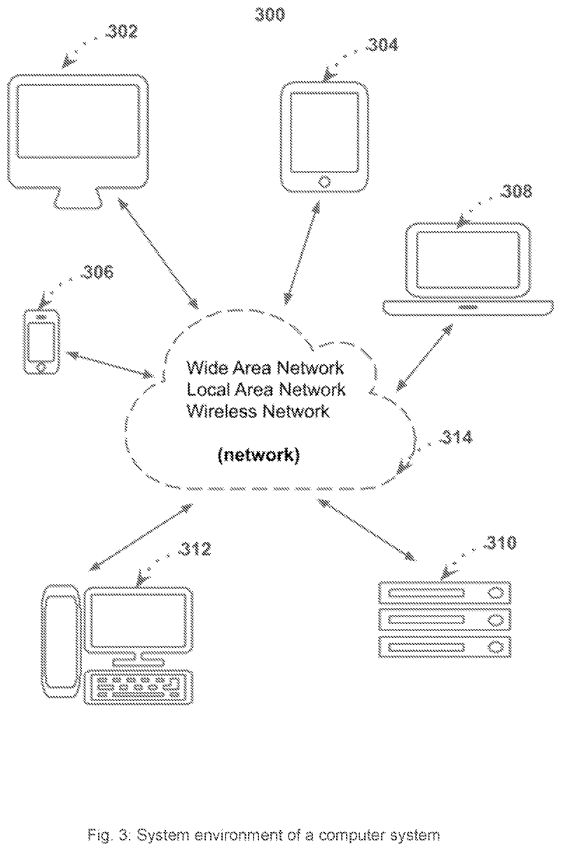

FIG. 3 illustrates a system environment of a computer system. This shows components of one embodiment in which embodiments of the invention may be practiced. Not all of the components may be required to practice the invention, and variations in the arrangement and type of the components may be made without departing from the spirit and scope of the invention. As shown, the system 300 of FIG. 3 may include a network 314. The network 314 includes, but not limited to, wide area network, local area network, wireless networks, internet, cloud network, universal serial bus, other forms of computer readable media, or a combination thereof. The system 300 may not include a network 314.

The system 300 includes one or more of the computer systems. The computer systems include, but not limited to, a desktop computer 302, tablet computer 304, mobile phone computing system 306, laptop computer 308, server computer 310, and personal computer 312. Generally, computer system 302 to 312 may include virtually any computer capable of executing a computer program and performing computing operations or the likes. However, computer systems are not limited and may also include other computers such as telephones, pagers, personal digital assistants, handheld computers, wearable computers, integrated devices combining one or more of the preceding computers. The computer systems 302 to 312 may operate independently or, two or more computer systems may operate over a network 314. However, computer systems are not constrained to these environments and may also be employed in other environments in other embodiments. Such operating computer systems 302-312, may connect and communicate using a wired or wireless medium by network 314.

Illustrative Computer System

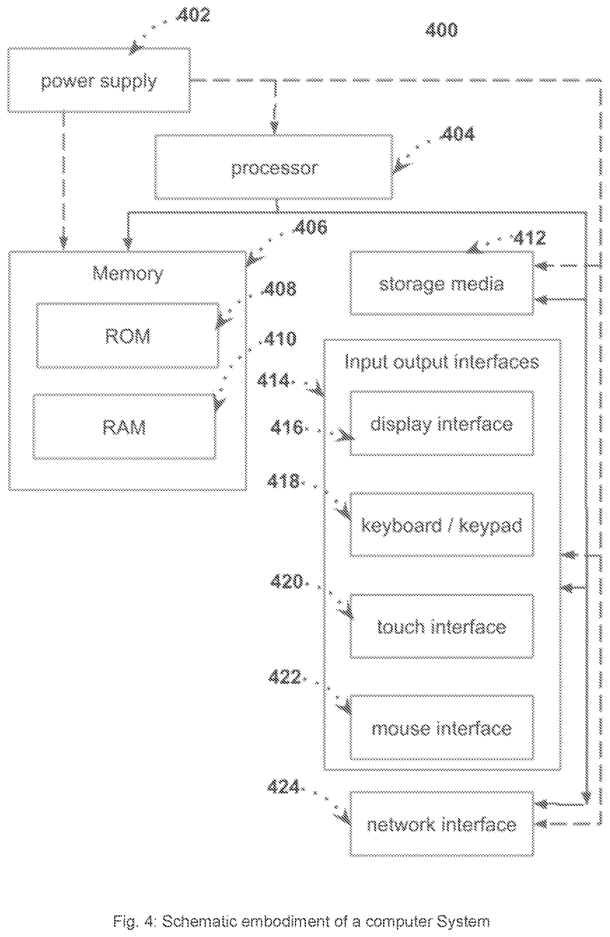

FIG. 4 illustrates a schematic embodiment of a computer system 400 that may be included in a system in accordance with at least one of the various embodiments. Computer System 400 may include many more or less components than those shown in FIG. 4. However, the components shown are sufficient to disclose an illustrative embodiment for practicing the present invention. Computer system 400 may represent, for example, one embodiment of a least one of computer systems 302 to 312 of FIG. 3.

As shown in the figure, computer system 400 includes a processor device 404, power supply 402, the memory 406, storage media 412, input output interfaces 414, network interface 424, and the subsystems in each of the above.

The power supply 402 provides power to the processor device 404, the memory 406, storage media 412, input output interfaces 414, network interface 424, and the subsystems in each of the above. A rechargeable or non-rechargeable battery may be used to provide power. The power may also be provided by an external power source, alternating current adaptor or a powered adaptor that recharges or works as an alternative to a battery.

The memory 406 includes read only memory ROM 408 and random-access memory RAM 410. The memory 406 may be included in a system in accordance with at least one of the various embodiments. This may include many more or less components than those shown in memory 406. The ROM 408 may be used to store information such as, computer readable instructions, applications, data, program modules, or other likes. The RAM 410 may be used to store information such as, computer readable instructions, applications, data, program modules, or other likes.

The storage media 412 includes one or many of random access memory, read only memory, hard disk drive, solid state disk drive, Electrically Erasable Programmable Read-only Memory, flash memory, compact-Disk read-only memory (CD-ROM), digital versatile disk (DVD), optical storage media, magnetic storage media, or the likes. Storage media 412 illustrates an example of computer readable storage media for storage of information such as computer readable instructions, data structures, program modules or other data. The storage media 412 stores a basic input output system BIOS or the like, for controlling low-level operation of computer systems. The storage media 412 also stores an operating system for controlling the operation of computer systems. Operating systems include and not limited to UNIX, Linux, Microsoft corporation's windows OS, Apple corporation's iOS, google corporation's Android, google corporation's chrome OS, Apple corporation's macOS. The operating system may include, or interface with a java virtual machine module that enables control of hardware components and or operating system operations via java application programs. Storage media 412 further includes data storage, which can be utilized by computer systems to store applications, and/or other data.

The input output interfaces 414 includes display interface 416, keyboard/keypad 418, touch interface 420, and mouse interface 422. The input output interface 414 may be included in a system in accordance with at least one of the various embodiments. This may include many more or less components than those shown in the figure.

The display interface 416 connects the computer system to a display device. Display device includes but not limited to, liquid crystal display (LCD), gas plasma, light emitting diode (LED), or any other type of display used with a computer. In some embodiments, display interface 416 may be optional.

The keyboard/keypad 418 is an interface that connects the computer system to a keyboard or to a keypad. The keyboard includes, but not limited to, a push button layout device or a touchscreen layout device. The keypad includes, but not limited to, a push button layout device or a touchscreen layout device. In some embodiments, keyboard/keypad 418 may be optional.

The touch interface 420 connects the computer system to a touch screen or a trackpad. The touch screen includes, but is not limited to, resistive touch screen or capacitive touchscreen. The trackpad includes, but is not limited to, touchpad or a pointing stick. In some embodiments, touch interface 420 may be optional.

The mouse interface 422 connects the computer system to a mouse. The mouse includes but not limited to, trackball mouse and optical mouse. In some embodiments, mouse interface 422 may be optional.

The network interface 424 includes circuitry for coupling a computer system to one or more other computer systems. The network interface 424 connects the computer system with one or more communication protocols and technologies including, but not limited to, GSM, GPRS, EDGE, HSDPA, LTE, CDMA, WCDMA, UDP, TCP/IP, SMS, WAP, UWB, WiMAX, SIP/RTP, or any of a variety of other communication protocols. Network interface 424 may be present, in which case, two or more compute systems may work together to practice the present invention. Network interface 424 may not be present, in which case, a standalone computer system works to practice the present invention. In some embodiments, network interface 424 may be optional.

Generalised Operations

The three objectives of the novelty detection are
1. identifying under-represented data
2. identifying unrepresented data and
3. identifying misrepresented data

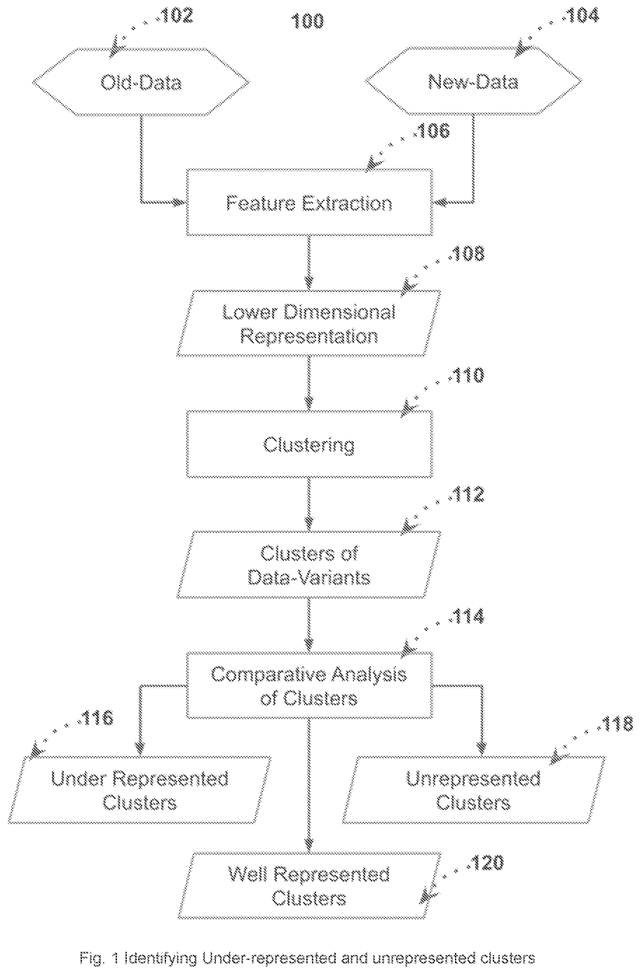

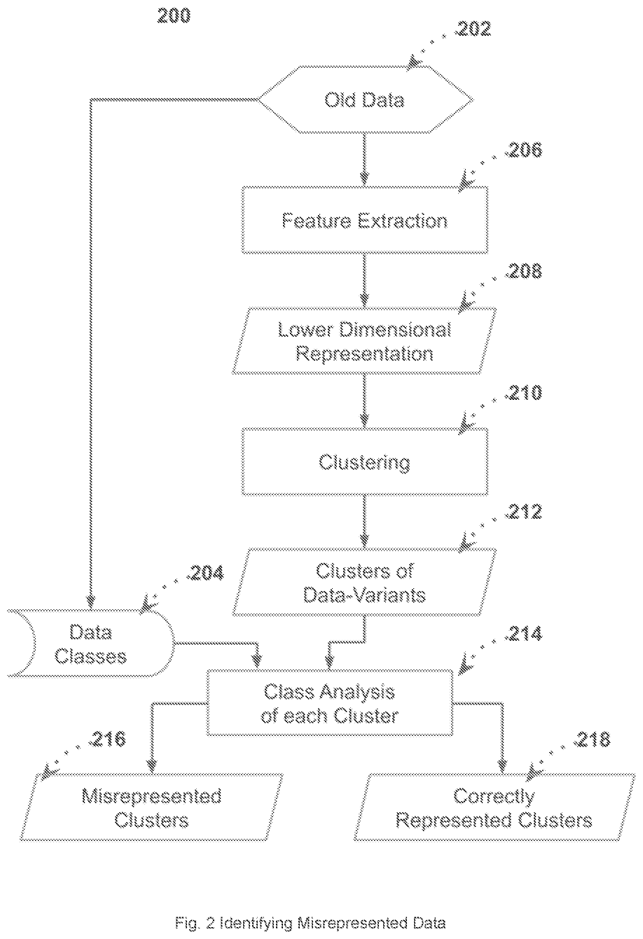

The proposed system for “novelty detection” is detailed using FIG. 1 and FIG. 2.

FIG. 1 details the “identification of under-represented and unpresented variants” with the process 100. The old-data 102 was used to train an AI system. The new-data 104 is acquired and the trained AI system will be used to classify the new data.

To identify the under-represented and unrepresented data, a feature extraction 106 is applied on each of the data points from both old-data 102 and new-data 104. Such feature extraction includes, but not limited to, auto-encoders, neural networks, ensemble trees, and dimensionality reduction algorithms.

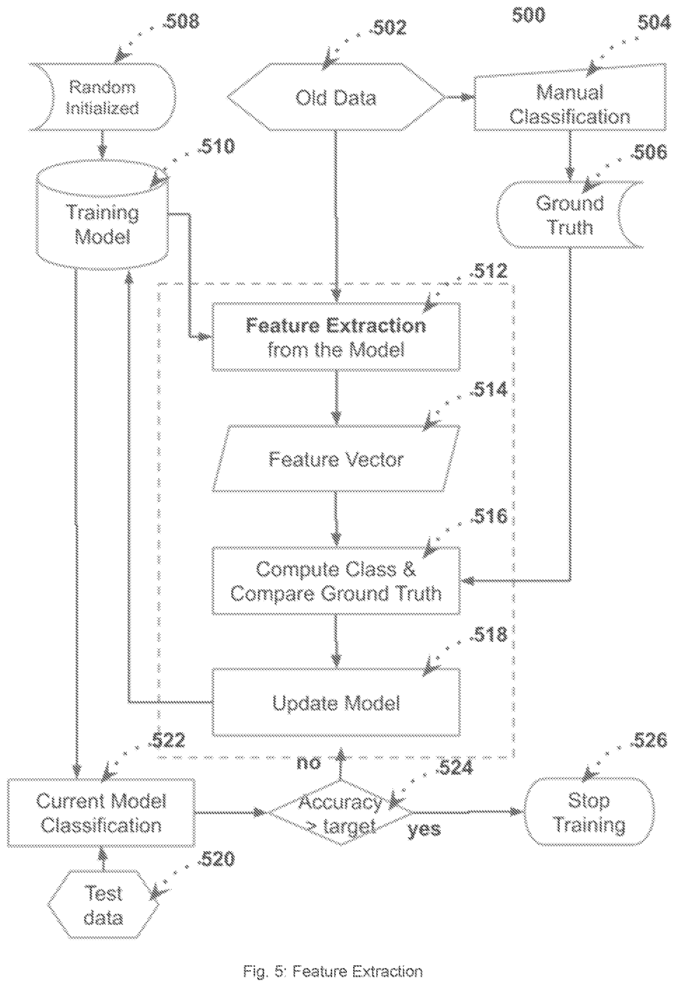

In one embodiment of the invention, feature extraction 106 is achieved by implementing a deep neural network as detailed in FIG. 5. The input old data 102 corresponds to old data 502. The Feature Extraction 106 corresponds to the Feature Extraction 512. The Lower Dimensional Representation 108 corresponds to Feature Vector 514.

FIG. 5 describes one embodiment of training a neural network for feature extraction.

Each of the data points in old data 502 is classified manually 504. Thus, each data point is associated with a class and that association is coded in a representation. This representation is called Ground Truth 506.

The artificial intelligence system or the neural network is defined by the training model 510. The training model is defined by a set of weights. When the training commences, the weights in the model are initialized to a set of random values 508.

The current training model 510 is used by the “Feature Extraction using the model” 512, to derive “feature vector” 514 for a data point. The feature vector of a data point is used to compute class and that is compared with the ground truth of that data point 516. The result of the comparison is used to update the model 518. A batch of data points is used in the steps 512, 514, and 516. At the end of that batch, the training model 510 is updated in step 518 for the entire batch.

The steps 512, 514, 516, and 518 are run iteratively to update the training model 510 for all data points in the train data 502 and also iteratively multiple times over the entire train data. One run or few runs across the entire dataset is an epoch.

At regular intervals between epochs or iterations, the training model 510 is used to compute the classification accuracy 522 of the test data 520. It is noted that the test data 520 is also classified by experts and a ground truth is associated with that. Using the ground truth associated with test data 520 and the current training model 510, classification accuracy of the current model 522 is computed. The accuracy is compared with target accuracy 524. If the current model accuracy is not greater than the target accuracy, then the training iterations are continued by steps 512, 514, 516, and 518. The training continues till the current model accuracy is greater than the target accuracy, and then the training is stopped 526.

The training model 510 and the feature extraction from the model 512 are used to compute the feature extraction 106.

The feature extraction 106 produces lower dimensional representation 108 of the input data point. The entire dataset is represented with corresponding lower dimensional representation dataset.

Clustering 110 is applied on the lower dimensional representation 108. Such clustering method includes, but not limited to, k-means clustering and birch.

In one embodiment of the invention, Clustering 110 is achieved by implementing birch algorithm. The Lower Dimensional Representation 108 corresponds to Feature Vector 604. The Clustering 110 corresponds to Construct CF Tree 608 and Combine Leaf-Nodes 610 together. The Clusters of Data-Variants 112 corresponds to Clusters 612.

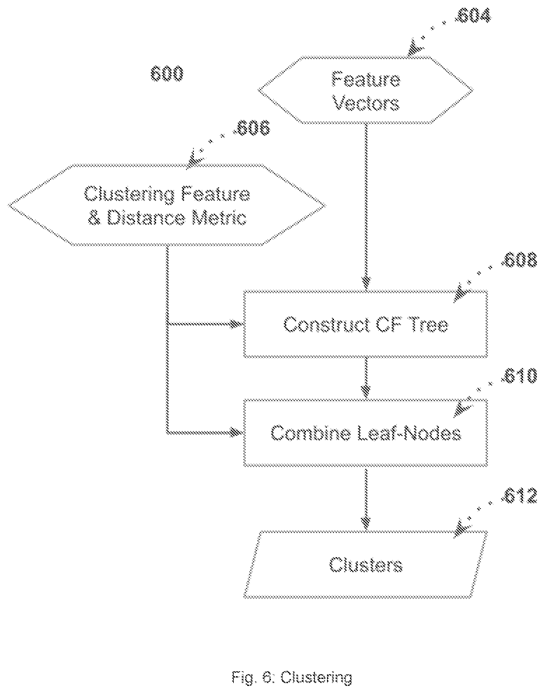

FIG. 6 describes one embodiment of clustering using CF tree.

The input is Feature Vectors 604. The clustering uses Clustering Feature and Distance Metric 606. The clustering is carried out in two steps. In the first step, the input Feature Vectors 604 are processed to Construct CF Tree 608, in which the clustering feature and distance metric 608 is used to assign every input data point in Feature Vectors 604 is assigned into a leaf-node in CF tree of Construct CF Tree 608.

Once all data points from Feature Vector 604 is processed in Construct CF Tree 608, the output of the step is taken as input to the second step Combine Leaf-Nodes 610. In this, the leaf-nodes are combined based on the distance computed between them using the Cluster Feature and Distance Metric 606. At the end of this, the Combine Leaf-Nodes 610 outputs Clusters 612.

The clustering 110 produces clusters of variants in the data 112. This essentially has partitioned the old-data and new data into clusters of each variant in the data.

On the clusters of variants 112, a comparative analysis 114 is carried out. For each and every variant in the new-data, the corresponding variant in old-data is compared.
If the number of data points in the old-data is smaller than a fixed value, then the cluster is declared as under-represented cluster 116
If the number of data points in the old-data is zero, then the cluster is declared as unrepresented cluster 118.
if neither of the above is true, then the cluster is declared as well-represented cluster 120

The objective of finding the under-represented and unrepresented variants is achieved by identifying under-represented clusters 116 and unrepresented clusters 118.

The pseudo code is as given below.

```
input old-data 102 consisting of n data points
input new-data 104 consisting of m data points
for each of the data point of old-data 102
  apply feature extraction 106
feature extraction 106 results in lower dimensional
  representation 108 of old-data 102
for each of the data point of new-data 104
  apply feature extraction 106
  feature extraction 106 results in lower dimensional
    representation 108 of new-data 104
for every lower dimensional representation 108
  apply clustering 110
clustering 110 results in clusters of data variants 112
Comparative Analysis of clusters 114:
for every cluster in clusters of data variants 112
  compare the number of data points in
    old-data 102 and new data 104
  if the number of data points in the old-data 102 is zero
  then mark that cluster as unrepresented 118
  if the number of data points in the old-data 102 is
    less than a threshold value
    percentage of the corresponding new-data 104
  then mark that cluster as underrepresented 116
  if the number of data points in the old-data 102 is
    greater than a threshold value
  then mark that cluster as well represented 120
```

FIG. 2 details “identification of misrepresented data” with the process 200. The process starts with old-data 202.

To identify the misrepresented data, a feature extraction 206 is applied on each of the data points from old-data 202. Such feature extraction includes, but not limited to, auto-encoders, neural networks, ensemble trees, and dimensionality reduction algorithms.

In one embodiment of the invention, feature extraction 206 is achieved by implementing a deep neural network as detailed in FIG. 5. The input old data 202 corresponds to old data 502. The Feature Extraction 206 corresponds to the Feature Extraction 512. The Lower Dimensional Representation 208 corresponds to Feature Vector 514.

The feature extraction 206 produces lower dimensional representation 208 of the input data point. The entire dataset is represented with corresponding lower dimensional representation dataset.

Clustering 210 is applied on the lower dimensional representation 208. Such clustering method includes, but not limited to, k-means clustering and birch.

In one embodiment of the invention, Clustering 210 is achieved by implementing BIRCH algorithm. BIRCH (balanced iterative reducing and clustering using hierarchies) is an unsupervised data mining algorithm used to perform hierarchical clustering over particularly large data-sets. With modifications it can also be used to accelerate k-means clustering and Gaussian mixture modeling with the expectation-maximization algorithm. An advantage of BIRCH is its ability to incrementally and dynamically cluster incoming, multi-dimensional metric data points in an attempt to produce the best quality clustering for a given set of resources (memory and time constraints). In most cases, BIRCH only requires a single scan of the database. BIRCH takes as input a set of N data points, represented as real-valued vectors, and a desired number of clusters K. It operates in four phases, the second of which is optional. The first phase builds a clustering feature (CF) tree out of the data points, a height-balanced tree data structure. In the second step, the algorithm scans all the leaf entries in the initial CF tree to rebuild a smaller CF tree, while removing outliers and grouping crowded subclusters into larger ones. In step three an existing clustering algorithm is used to cluster all leaf entries. Here an agglomerative hierarchical clustering algorithm is applied directly to the subclusters represented by their CF vectors. It also provides the flexibility of allowing the user to specify either the desired number of clusters or the desired diameter threshold for clusters. After this step a set of clusters is obtained that captures major distribution pattern in the data.

The Lower Dimensional Representation 208 corresponds to Feature Vector 604. The Clustering 210 corresponds to Construct CF Tree 608 and Combine Leaf-Nodes 610 together. The Clusters of Data-Variants 212 corresponds to Clusters 612.

The clustering 210 produces clusters of variants in the data 212. This essentially has partitioned the old-data into clusters of each variant in the data.

On the clusters of variants 212, a class analysis 214 is carried out. For each and every variant in the old-data, the composition of data points is analyzed.
if a percentage of data points in a cluster is above a threshold value is in one class, and remaining data points are in other classes, then the cluster is declared as misrepresented cluster 216. In one embodiment of the invention the threshold value is implemented to be, but not limited to, 80 percentage.
If a cluster was not declared as misrepresented in the earlier step, then itis declared as correctly represented cluster 218

The misrepresented clusters have a large percentage of data points in one class. And the remaining data points are the misrepresented data. The objective of finding the misrepresented data is achieved with this.

The pseudo code is as given below.

```
  input old-data 202 consisting of n data points
  input the data classes 204 for each of the old-data-202
  for each of the data point of old-data 202
    apply feature extraction 206
  feature extraction 206 results in lower dimensional
    representation 208 of old-data 202
for every lower dimensional representation 208
  apply clustering 210
clustering 210 results in clusters of data variants 212
Class Analysis of clusters 214:
for every cluster in the cluster of data variants 212
  Analyze the composition of data points
  if a large percentage of data points in a cluster is
    in one class, and remaining data points are
    in other classes,
  then declare the cluster as misrepresented cluster 216
  else declare as correctly represented cluster 218
```

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on standalone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM).

Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Various modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

All patents, published patent applications and other references disclosed herein are hereby expressly incorporated in their entireties by reference.

While the invention has been described with respect to preferred embodiments, those skilled in the art will readily appreciate that various changes and/or modifications can be made to the invention without departing from the spirit or scope of the invention as defined by the appended claims.

Many of the methods are described in their most basic form, but processes can be added to or deleted from any of the methods and information can be added or subtracted from any of the above description without departing from the basic scope of the present embodiments. The applications of the disclosed invention discussed above are not limited to certain treatments or regions of the body but may include any number of other treatments and areas of the body. Modification of the above-described methods and devices for carrying out the invention, and variations of aspects of the invention that are obvious to those of skill in the arts are intended to be within the scope of this disclosure. Moreover, various combinations of aspects between examples are also contemplated and are considered to be within the scope of this disclosure as well.

1. A method of processing data for an artificial intelligence (AI) system,) comprising:
receiving data points for old-data and new-data;
extracting features of the data points to produce a lower dimensional representation of the data points;
clustering the lower dimensional representation into one or more clusters to produce a set of clusters of data points;
comparing the clusters of old-data with the clusters of the new-data;
identifying under-represented clusters in the old-data, in comparison to the corresponding clusters in the new-data; and
identifying unrepresented clusters in the old-data, in comparison to the corresponding clusters in the new-data.

2. The method of claim 1, comprising, for each cluster, comparing the number of data points in old-data and new-data and if the number of data points in the old-data is zero, marking the cluster as having unrepresented data.

3. The method of claim 1, comprising, for each cluster, comparing the number of data points in old-data and new-data and if the number of data points in the old-data is less than a threshold value or a predetermined percentage of corresponding new-data, marking the cluster as having underrepresented data.

4. The method of claim 1, comprising, for each cluster, comparing the number of data points in old-data and new-data and if the number of data points in the old-data is greater than a threshold value, marking the cluster as having well represented data.

5. The method of claim 1, comprising providing the data to a neural network model, a deep learning neural network model, a convolutional neural network model, or a deep learning neural network model.

6. The method of claim 1, wherein the clustering comprises applying BIRCH.

7. The method of claim 1, wherein the clustering forms a clustering feature (CF) tree with leaf nodes.

8. The method of claim 1, comprising generating a lower dimensional representation from a feature vector.

9. The method of claim 1, comprising applying auto-encoders, neural networks, ensemble trees, or dimensionality reduction to perform feature extraction.

10. The method of claim 1, comprising identifying data variants that are under-represented and unrepresented in the old-data using the new-data.

11. A method of processing data for an artificial intelligence (AI) system, comprising:
extracting features of the data to produce a lower dimensional representation of the data points;
grouping the lower dimensional representation into clusters using a clustering algorithm, to produce a set of clusters of data points;
comparing the classes of data points within the clusters; and
identifying misrepresented data points within the clusters.

12. The method of claim 11, comprising, for each cluster, comparing the classes of data points within a cluster and upon finding datapoints of one class exceeding a predetermined threshold over remaining data points of other classes, marking the remaining data points as misrepresented data.

13. The method of claim 11, comprising, for each cluster, comparing the classes of data points within a cluster and upon finding all datapoints of a single class in the cluster, marking the cluster as correctly represented data.

14. The method of claim 11, comprising providing the data to a neural network model, a deep learning neural network model, a convolutional neural network model, or a deep learning neural network model.

15. The method of claim 11, wherein the clustering comprises applying BIRCH.

16. The method of claim 11, wherein the clustering forms a clustering feature (CF) tree with leaf nodes.

17. The method of claim 11, comprising generating a lower dimensional representation from a feature vector.

18. The method of claim 11, comprising applying auto-encoders, neural networks, ensemble trees, or dimensionality reduction to perform feature extraction.

19. The method of claim 1, comprising identifying data variants that are under-represented and unrepresented in the old-data using the new-data.
